(19) United States
(12) Patent Application Publication
(10) Pub. No.: US 2010/0007233 A1
(43) Pub. Date: Jan. 14, 2010

(54) DC Pulse Electric Generating System and Methods Thereof

(76) Inventor: Taras Sozanski, Manvel, TX (US)

Correspondence Address: TARAS P. BEMKO, 301 GULF FREEWAY SOUTH, LEAGUE CITY, TX, 77573, US

(21) Appl. No.: 12/172,269

(22) Filed: Jul. 14, 2008

(51) Int. Cl. H02K 21/38; H02K 53/00

(52) U.S. Cl. 310/168; 415/916

(57) ABSTRACT

The present system is generally relates to a new method and apparatus for the creation of a DC electric pulse involving the use of stationary magnets, including permanent magnets and electro-magnets, stationary conductor coils, and a magnetic shield that opens and closes magnetic gateways. When a magnetic gateway is opened and closed, the magnetic flux is disturbed. The magnetic flux penetrates the coil at differing proportions, creating a flow of electrons in the conductor. The present system provides for less heat generation and produces substantially no exhaust fumes or radiation. Further, the present system operates with very low hysteresis losses, eddy currents, magnetic repulsion or drag, destructive back emf, and minimal impedance losses.

### RELATED APPLICATION

This application claims the benefit of U.S. utility patent application Ser. No. 10/859,949 filed Jun. 4, 2004 and entitled “DC Pulse Electric Generating System” which is hereby incorporated by reference herein, and claims the benefit thereof.

### TECHNICAL FIELD

The present disclosure relates to an electric generating system and, more particularly, to a method and apparatus for the generation of DC electric pulses from magnets, in an efficient manner and with limited heat generation.

### BACKGROUND OF THE INVENTION

An electric generator is a machine that converts mechanical energy into electric energy. The source of the mechanical energy could include, but is not limited to a windmill, a spinning turbine in moving water, gas or steam produced from oil, coal, gas and biomass combustion, geothermal, and nuclear fission, gas and carbon-based fuel cells, hydrogen fuel cells, and the like. Many of these sources converting chemical energy into mechanical energy and then into electricity or directly into electricity. Commercial generators typically fall into two categories. One category is often used in power plants in which a magnetic field is created and the permanent or electro magnetic field is spun around stationary coils producing current. The other category is often used in automobiles to create electricity in which an electro-magnetic stationary coil is energized and then collapsed in the presence of a conductor. The instant system uses a different option of creating electricity in which neither the coils nor the magnets are spun and electricity is created through the disruption of a magnetic field inside a stationary coil. The conventional electrical generation technology is being presented here as a basis for comparison with the direct current (DC) pulse generator described herein.

Conventional generators operate basically on the same practical principles as they have for many years. The typical conventional electric generator consists of two main parts, a rotor and a stator. The rotor is a disk or a cylinder, consisting of electro magnets, ceramic or other permanent magnets and coils made from copper wire wound on laminated iron poles. The stator includes coil windings, magnets, electro-magnets or their combination. When the rotor is rotated, the magnets cause electrical current to flow within the winding wires. Given their mechanical structure, it is not likely to eliminate hysteresis, eddy currents, magnetic repulsion, and counter electromotive force (emf), all which are common in conventional electric generators. Over the last century, many devices have been created to limit the effects of these forces, these included various brush and brushless designs, lots of copper windings, surge suppressors, high tech laser laminated silicon steel components, and the like. Typically, these generate heat and require cooling to keep the generators spinning and not sustaining heat damage. Further, a conventional generator requires a large infrastructure cost including internal combustion engines; turbines; large thermal generating plants using combustion of oil, gas, coal or biomass; chemical fuel cells; or nuclear reactors. Due to the necessary requirement for efficiencies of large scale in conventional power generation, the resulting energy distribution system is centralized and the by-products of the reaction process, including un-combusted fuel in the form of smog, hydro-carbons and radiation are produced and have to be accounted for.

### BRIEF DESCRIPTION OF DRAWINGS

For a further understanding of the nature and objects of the instant disclosure, reference should be had to the following detailed description, taken in conjunction with the accompanying drawings, in which like elements are given the same or analogous reference numbers.

FIG. 1 illustrates a schematic view of an embodiment of the generator and motor operating as a unit;

FIG. 2 illustrates a schematic representation of a closed magnetic circuit;

FIG. 3 illustrates a schematic representation of a partly opened and partly closed magnetic circuit;

FIG. 4 illustrates a schematic representation of an open magnetic circuit;

FIG. 5 illustrates a top view of the magnetic shield showing two magnetic gateways;

FIG. 6 illustrates a cross sectional view of the magnetic shield further illustrating laminations;

FIG. 7 illustrates a top view of conductor coil;

FIG. 8 illustrates a side view of a conductor coil;

FIG. 9 illustrates a side view of the magnetic plate of a permanent magnet embodiment;

FIG. 10 illustrates a side view of the magnetic plate of an electro-magnetic embodiment;

FIG. 11 illustrates an end view of the magnetic plate of a permanent magnet embodiment;

FIG. 12 illustrates a side view of a magnetic motor plate;

FIG. 13 illustrates a cross sectional view of a magnetic motor plate;

FIG. 14 illustrates a side view of a structural wall of the motor;

FIG. 15 illustrates a end view of the structural wall of the motor;

FIG. 16 illustrates a partial cross sectional view of the axle with magnetic bearings;

FIG. 17 illustrates a representation of the electrical circuit of the generator;

FIG. 18 illustrates representation of the electrical circuit of the motor; and

FIG. 19 illustrates an analysis of the output wave data from an operating DC pulse generator.

### DETAILED DESCRIPTION OF EMBODIMENTS

Described herein is a system for the generation of DC electric pulses from magnets, in a manner that is efficient and does not produce substantial heat. The DC pulse generator is available to provide a just-in-time power source that is overall portable. The DC pulse generator offers levels of performance unattainable with conventional generators through greater energy efficiency, improved operational flexibility, reduced size and weight, and lower life-cycle cost.

The DC pulse generator offers several advantages over conventional generators such as, but not limited to, simple low loss construction, no coils on the rotor, no brushes or contacts, low power loss within the rotating parts, smaller copper windings, compact design, light weight, operates with very low heat production, high power density (for example 20 Kilowatts (KW) of electricity per cubic foot), minimal resistance losses, substantially little or no heating effect of current, no armature windings, minimal field winding, no core losses due to hysteresis, no eddy currents in the armature, internal components and pole faces, minimal mechanical losses due to bearing friction, brush friction and windage losses where friction is created between moving parts and air, no stray loads caused by the eddy currents in the armature conductors, no short-circuits in the coil undergoing commutation, pulsations in magnetic flux in various parts, or any distortion of the magnetic flux by the mechanical parts.

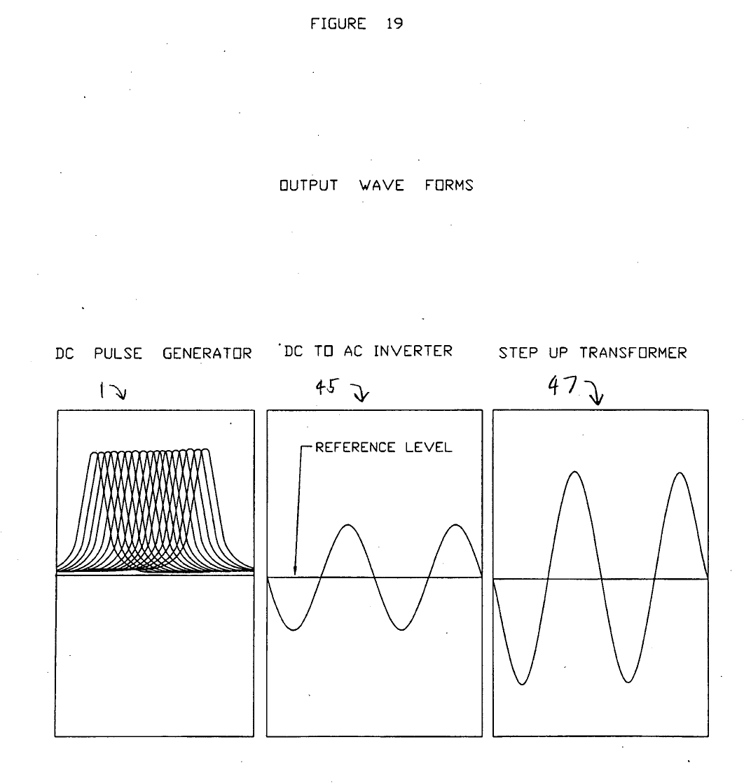

The power the generator 1 produces can be tied into standard industrial power equipment, including inverters and transformers. In the alternative, DC or AC/DC powered motors attached to conventional alternating current (AC) generators produce a large variety of conventional power generation options. FIG. 19 illustrates how this DC pulse generator generates DC power and then this power is converted to AC power in an inverter whose function is to convert DC to AC. Preferably, the output of the inverter is then fed to a transformer, which can be used for a step-up or a step-down voltage and has a further advantage of smoothing out any non-sinusoidal waveform irregularities.

This system has been developed through extensive testing as over 5,000 models have been manufactured and statistics were compiled. These models included both permanent magnet designs and electro-magnetic designs. In one embodiment, the permanent magnet sheet or plate 21 is replaced with electro-magnets. These electromagnets are wound in such a manner that inside them there are grooved coils with a circulating refrigerant or coolant. The space between the layers of wires inside the coil has thermally conducting materials like carbon nanotubes that conduct heat from inside the coil to the outside of the coil and into the refrigerant. The space around the coils is filled with a refrigerant. Further, the polarity is such that one side of the electromagnet coil is a north pole and the other is a south pole. It is most preferable to have the electromagnet coils as close as possible to 90 degrees to the direction of the winding of the coils that produce electricity. Electricity that is produced is a result of the effective conversion of the energy normally contained and locked up within the magnetic flux of a magnet.

The losses in this invention are relatively small compared to conventional generators as the conventional generator requires energy to overcome hysteresis due to changing magnetic fields in the conductor as the conductor is effectively moved through a magnetic field. This results in electrical eddy currents and heat. This invention avoids this hysteresis losses as the same polarity of the magnet is exposed to the same conductor over and over again as the magnetic shield with non magnetic shielding sections moves between the magnet and coil. Electricity is actually produced during the disturbance of the conductor by the magnetic flux. The system described herein efficiently taps into that magnetic flux substantially without heat, radiation, or virtually any other detectable exhaust. This occurs through the creation of a device that effectively disturbs the magnetic field in a coil without moving the coil or the magnet. The system described herein substantially eliminates or reduces the infrastructure costs associated with electrical power generation. Within the generator, it substantially reduces and/or eliminates hysteresis losses, eddy currents, magnetic repulsion and counter emf. Further, it creates little environmental impact with clean electricity as its product.

The varying magnetic flux level creates the release of a large amount of electrons. Through experimentation it has been shown that the popular belief that the magnetic polarity of a conductor has to change in order for current to flow in the conductor is not necessarily the mechanism that releases the electrons in a conductor. Rather it is the change in magnetic flux levels that a conductor is exposed to that releases electrons. That changing magnetic flux level can be created by:
1. The motion of the magnet causing the magnetic flux to cut across the conductor as used in a typical AC generator; and/or
2. The increasing and subsequently the resulting collapse of the magnetic field around a conductor as used in a typical alternator; and/or
3. The relative fluctuation of flux in the conductor as the magnetic flux field is disturbed as used in this DC pulse generator.

The current is substantially always the same polarity with varying intensities, ranging from near zero when the magnetic shield 26 interferes with the magnetic flux 5 and going to a maximum when the magnetic gateway 27 is open and allows for maximum flux 5 penetration. At no point is the magnetic polarity of the coil changed which is mandatory of all AC generators. The changing of polarity in AC generators creates huge energy losses typically referred to as hysteresis and eddy currents. These two losses typically exceed 90% of the energy used in the operation of the typical AC generator. When magnetic drag and back emf is factored with the hysteresis and eddy currents in a conventional AC generator, the actual losses exceed 95% of the operating energy of the generator. The present system does not create current based on alternating polarity and thus does not experience these losses (hysteresis, eddy currents, magnetic drag, and back emf) to any significant degree. The losses associated with operation of the generator are a combination of losses that are a result of changes in current, voltage, and resistance within the conductors. This is commonly known as impedance which is a vectoral summation of XL inductive reactance which measures the changes in current and is expressed in ohms, XC capacitance reactance which measures the changes in voltage and is expressed in ohms, and R resistance and is expressed in ohms. Resistance is by far the largest component of the losses associated with this generator 1 that can be controlled by the operator. Thus the operation of the generator 1 at the lowest practical temperature is the most efficient. The relationship of the impedance losses to temperature approximates the resistance of copper and for every 8° C. temperature change, there is a 5% change in impedance. Mechanical refrigeration is desirable and practically necessary. Impedance losses appear as heat. By pre-cooling the generator prior to use, the amount of heat gain and impedance losses are minimized.

Conventional generators have significant losses which include hysteresis losses, eddy current losses, magnetic losses, and back emf losses. Hysteresis losses are caused by moving magnetic fields in magnetically susceptible metals like copper, steel or iron. As the magnetic flux field moves through the molecules in the metal, the electrons and molecules orientate towards the magnetic flux. As the magnetic flux leaves such metal, the molecules of the metal have a memory of where the magnetic field was last oriented. This last orientation has to be re-oriented in a conventional generator because the next approaching magnet has its own flux waves that the metal has to orient itself to. This constant magnetic reorientation causes the metal to get hot, which in turn causes the entire motor to get hot, and after a certain point, the hotter it gets, the more the magnetism decreases in the core windings or in the magnets themselves. The present system avoids this through the use of stationary coils and magnets thus, providing substantially little or no hysteresis losses.

Eddy currents are created by moving magnetic fields, which cause the flow of current in a conducting wire. The current flows through the wire when there is a load on the generator, or when current is input into the windings of a motor. In conventional generators, the moving magnetic field around the wires intersects with other wires and with the metals of the stator, rotor, nuts and bolts, and all other items not insulated from the magnetic field. This stray electrical current flow produces additional heat and a secondary magnetic field that interferes with the primary current flow, impeding the primary current flow. This impedance lowers the power output of the motor or generator. This is called eddy current loss requiring additional force to overcome it. Conventional generators have iron-based metal cores of the windings. It is difficult to eliminate iron-based metal because it is the difficult to easily find material tough enough to resist the heat and the mechanical wear and tear. The present system substantially eliminates most of the metal as the coil 22 is stationary and the magnetic field 5 fluctuates when with the magnetic gateway 27 changes its characteristics. Eddy currents are substantially eliminated and substantially no eddy currents are detectable using conventional measurement equipment.

The magnetic loss occurs when a moving magnet approaches a conductor, the conductor becomes magnetized with the same polarity as the approaching magnet. When a magnet moves close to a coil, the magnet causes the coil to become an electromagnet with the same polarity as the magnet. In magnetism, like poles repel each other and such repulsion causes significant drag on the rotor. The closer these magnets, of the same poles, approach each other the greater is the repelling force. Generally, the stronger the magnets, the greater the repulsion and magnetic drag. This magnetic repulsion or drag slows down the motion of the generator, making it more difficult to turn the rotor, which, of course, reduces the effective power output relative to the power input.

When a magnetically created or induced current is broken, there is a collapse of the associated magnetic field within the conductor wire, which causes the electrons to move in the opposite direction. This is called back emf and the motor and generator industry has devised numerous devices to lessen and/or control this destructive current. The present system substantially eliminates the destructive power of back emf and harnesses it into productive output from the generator 1.

A source of motion is an efficient variable speed permanent magnet and/or electro-magnet motor 3, which combines a spinning plate 30 with embedded magnets 20 and stationary electro-magnets 37 and sensors 36 located along the stationary walls 32. The electro-magnets 37 are energized for under 20-milliseconds and repulse the passing magnets 20 mounted on the plate 30 creating motion. The coils 22 are designed to have low impedance which means short wire lengths and thick cross sections. The energy source for the motor 3 is a battery.

The system described herein provides for the produced power to be tied into standard industrial power equipment, including inverters and then transformers. In the alternative, DC or AC/DC powered motors attached to conventional AC generators produce a large variety of conventional power generation options. Thus, the present system enables power in a variety of sizing options, ranging from small appliances, computers, homes, commercial and industrial applications and regional power requirements. The instant system can be operated in a variety of power grids or separately from power grids.

The conventional generator and alternator use magnetism in an inefficient manner. They depend on creating a new magnetic field of the same polarity in the other conductor. The generator further depends on bringing these two like poles to a very close distance using an approaching magnetic field. This consumes much energy. In contrast, the present system has no moving coil or magnet and uses the concept of disturbing the existing magnetic field to create electric current in a stationary coil.

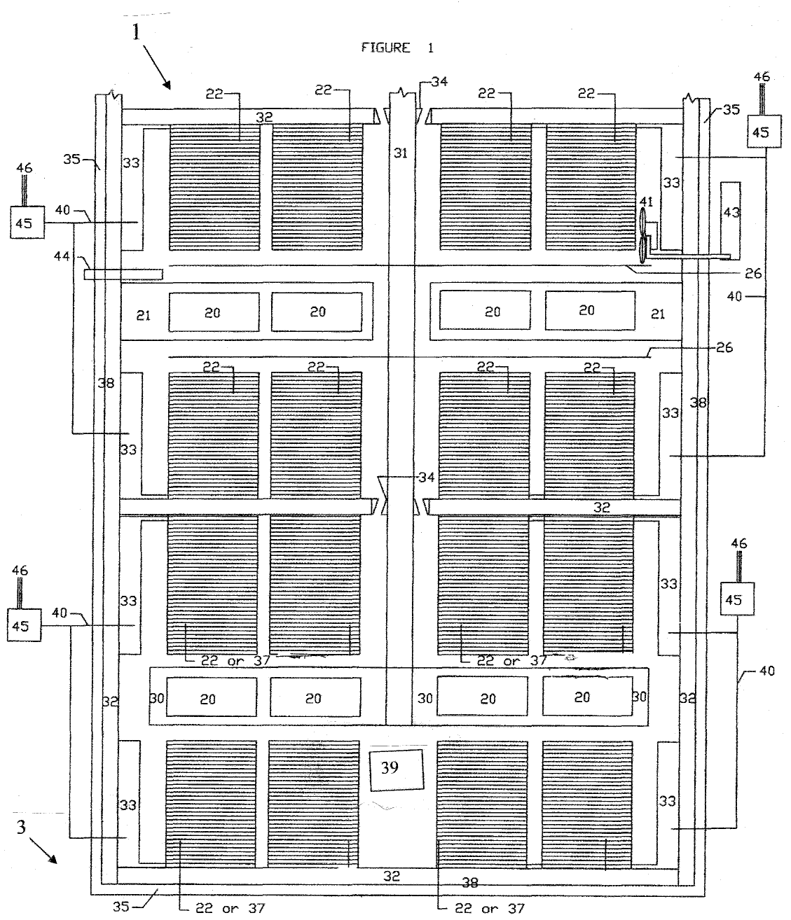

FIG. 1 illustrates an embodiment of the generator 1 and motor 3 operating as a unit. The generator 1 does not spin the magnets 20 nor the coils 22. Magnets 20 maybe any variety of magnets including, but not limited to, a permanent magnet or an electromagnet. The generator 1 effectively spins the magnetic field by opening and closing the magnetic field on the coils 22 changing its intensity. The opening and closing of the magnetic field is described in further detail herein below. In this embodiment, generator 1 and motor 3 are preferably enclosed by a structural wall or enclosure 32. It should be appreciated that the enclosure 32 can be a variety of enclosures such as a retaining wall or may otherwise vary depending on the physical size of the motor 3 and generator 1, user preferences, various specifications, or any combination thereof. Thus, the specific type of enclosure 32 should not be viewed as a limitation herein. As further illustrated in FIG. 1, motor 3 and generator 1 are preferably separated by at least a portion of enclosure 32. Both generator 1 and motor 3 preferably contain an arrangement of bus bars 33 which function to facilitate a transfer of the generated electrical power from the motor 3 and/or generator 1 to a consumer of the electrical power. It should be understood that both motor 3 and generator 1 will generate electricity. However, the generator 1 is much more efficient at electrical energy production and does so without producing the additional heat typically experienced in such devices.

In one embodiment, the bus bar 33 is a copper bus having an internally grooved copper tube or tubes inserted throughout its length for cooling purposes. The bars 33 preferably extend through the wall 32 of the DC pulse generator 1. The portion of the bars 33 extending beyond the generator 1 are configured to allow connection to inverter 45 or if necessary, the transformer 47. The connection is preferably a conventional connection that provides easy and/or quick connectability. Preferably, the bus bar 33 is connected to one or more leads from each coil 22. Preferably, leads from each coil 22 are of the same polarity as the magnet 20. It should be understood that the leads may connect to the magnet 20 or from one or more magnetic wheels, magnetic plates, and/or sheets. It should be understood that if the polarity of the magnet 20 differs from a homogeneous polarity within the coils 22, attached to that bus bar 33, then a diode should be used between the bar 33 and the coil 22. In one embodiment, the bus bar 33 is coated with an electrical insulator comprised of materials including AlN (Aluminum Nitride) and further coated in a plastic based insulator. In another embodiment, the bus bar 33 is coated in a plastic based insulator. Preferably, the output of the same polarity coils 22 is connected to a common bus bar 33. In one embodiment, the output of the coils 22 is connected to two bus bars 33, with each end of the coil 22 connected to its own bus bar 33 along with other coils 22 being powered by the same polarity of magnets 20.

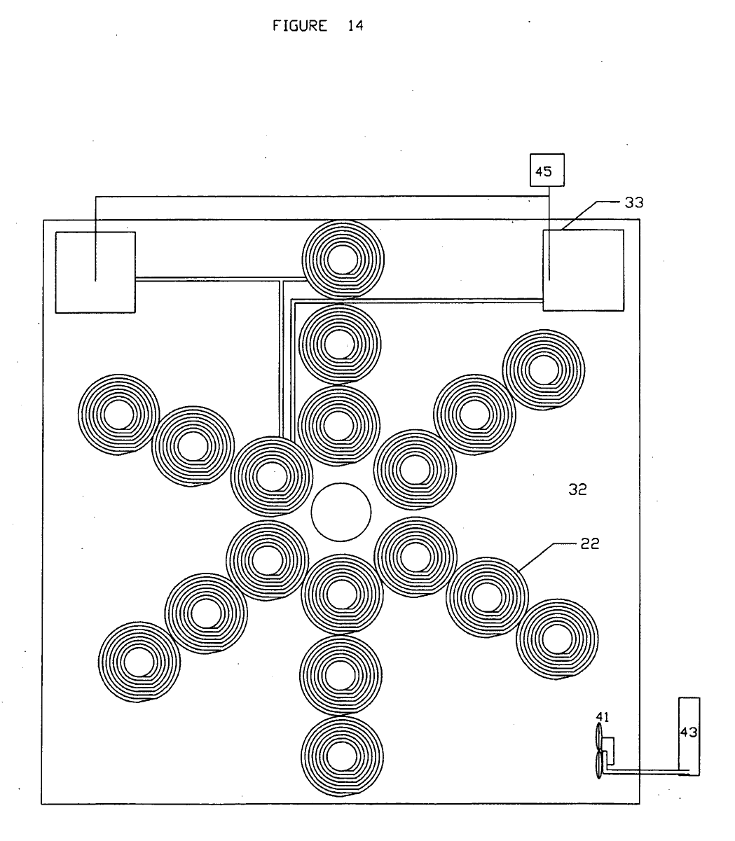

Both generator 1 and motor 3 preferably transfer the electrical power via conducting lines 40. Lines 40 may connect directly to an inverter 45 which converts the power from DC to AC or may be transferred to other devices depending on the designated usage of the power. Other power convertors such as diodes or transformers 47 may also be utilized along with inverter 45 or instead of inverter 45. Typically, the inverted/modified power is transferred via transmission lines 46 to a designated consumer or device. Generator 1 and motor 3 may also contain a cooling system comprising a fan 41 and a cooling source 43 (see FIG. 14 for a cooling system for the motor 3). It should be appreciated that cooling source 43 may be any conventional cooling system such as but not limited to a type of heat exchanger or other air cooler and/or chiller. It should be further appreciated that in certain environments a cooling system may not be necessary or utilized.

Still referring to FIG. 1, generator 1 further comprises one or more coils 22. Coils 22 are preferably separated from magnets 20 by the magnetic shield 26. Further, magnets 20 may be retained or secured to a magnetic plate 21.

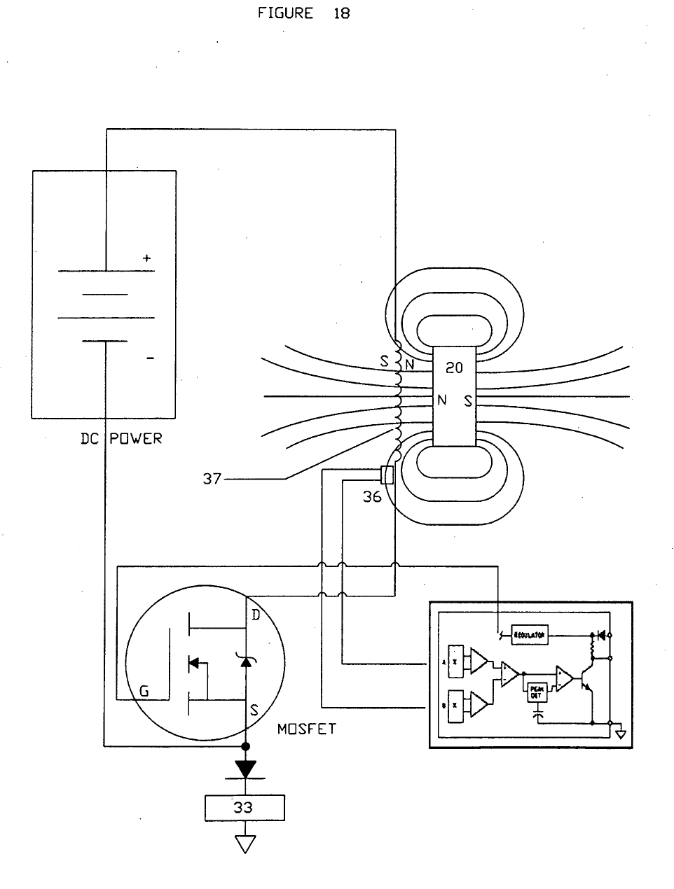

Motor 3 further comprises either coils 22 or electro magnets/electro magnet coil 37. It should be noted that a motor 3 could be designed having coils, electro magnets, and electro magnetic coils and such design differences are foreseeable and thus within the scope of the invention. The magnets 20, of motor 3 are preferably mounted on a disk 30. Disk 30 is at least partially controlled with a speed control 39. The importance of speed control 39 is described herein below. An efficient variable speed permanent magnet and/or electromagnet motor 3 may be comprised of permanent magnets 20 embedded in a disk 30 that moves combined with stationary sensors 36 (see FIG. 18) and stationary electro-magnets.

In the embodiment illustrated in FIG. 1, an axle 31 is mounted so as to extend between generator 1 and motor 3. Axle 31 may be of a variety of materials including, but not limited to, a non austenitic metal, a non electrically conducting material including, but not limited to, glass, plastic, adhesives, ceramics, materials containing filler materials such as fibers, strands, mats, cloths, and composite laminations or combinations thereof. Regardless of the material (preferably one that is not electrically or magnetically conductive), it is preferred that the material is molded, shaped, or formed into a shaft.

Bearings 34 are preferably mounted to allow axle 31 to pass through enclosure 32. In one embodiment the magnetic shield 26 is attached to bearings 9 that are made from magnetic material. Axle 31 is preferably attached to magnetic shield 26 (in generator 1) and to the disk 30 (in motor 1). Preferably axle 31 transfers a rotational force to the disk 30 and magnetic shield 26. If necessary, the atmosphere inside enclosure 32 can be controlled. It should be understood that if generator 1 and motor 3 are physically separated, separate axles 31 may be utilized. Such separate axles 31 may be joined by conventional joints or other transmission type of devices. It is preferable that the magnetic shield 26 be mechanically attached to the axle 31 and electrically isolated from the axle 31.

Enclosure 32 may be airtight, drained by vacuum and charged with a different atmospheres through a gas tight control valve 44. Preferably, the most efficient atmosphere is one of hydrogen. However, hydrogen may be destructive to certain elements including, but not limited to the carbon in steel. Further, hydrogen, due to its explosive nature, is inherently dangerous in certain environments. Thus, other operating atmospheres such as helium, refrigerant, carbon dioxide or nitrogen may be preferred.

Enclosure 32 may also contain or be contained within a protective shell 38. The protective shell 38 may be further insulated by at least one layer of insulation 35. The enclosure 32 may be of materials such as, but not limited to a non austenitic metal, a non electrically conducting material like glass, plastic, and the like. Other materials maybe certain adhesives and/or ceramics containing filler materials comprising fibers, strands, mats, cloths, and the like or composite laminations of any combinations of the above components. Preferably, these materials or combinations thereof are molded, formed, and/or shaped into a flat plate comprising the enclosure 32.

The protective shell 38 may be composed of sheets of material such as, but not limited to, a non austenitic metal, a non electrically conducting material including glass, plastic, and the like, adhesives, ceramics containing filler materials such, but not limited to, fibers, strands, mats, cloths, and the like. Other materials may include composite laminations of the above components. Preferably, these materials or combinations thereof are molded, formed, and/or shaped into a flat plate comprising the protective shell 38. Preferably such shell 38 construction is not electrically or magnetically conductive.

Further, the one or more layers of magnetic shielding material, of the protective shell 38 are preferably designed to shield the generator 1, the motor 3, and magnets 20 from any external magnetic flux. The insulation 35 may be a ceramic insulation held in a polymer matrix having high emissive characteristics to absorb heat energy and redirect the heat energy away from the motor 3 and generator 1. In one embodiment, at least one layer of the skin of shell 38 is an austenitic steel containing vanadium that has been reduced by cold rolling to produce a material that is approximately in a thickness range of 1 mm to 15 mm and has a minimum strength of approximately 100 KSI. In another embodiment at least one layer of shell 38 may be a fabric that absorbs high velocity impact and distributes it over a larger area.

It should be understood that the operation of the generator 1 is smoother depending on the composition of the protective shell 38. Some examples, not intended as limiting, include a shell 38 that 1) seals enclosure 32 from substantially all infiltration of air (i.e. an airtight enclosure), 2) is airtight and allows to depressurize the enclosure 32 thus allowing operation in partial vacuum, 3) is airtight and allows a cycle of depressurizing and re-pressurizing the enclosure 32 where the re-pressurization is preferably using with certain non corrosive gasses, including, but not limited to, helium, nitrogen, argon, neon, refrigerant and the like as a purging agent or atmospheric gases thus allowing operation in partial vacuum.

Preferably, the insulating coating 35 may be highly emissive and readily absorbs energy and redirects away from the enclosure 32. In one embodiment, the coating 35 is of pliable material that allow impact absorbence with little or no damage. In another embodiment, the coating 35 contains more than one type, size, or style of ceramics mixed in a plastic matrix. The matrix allows the ceramics to self-layer according to type and size prior to solidifying.

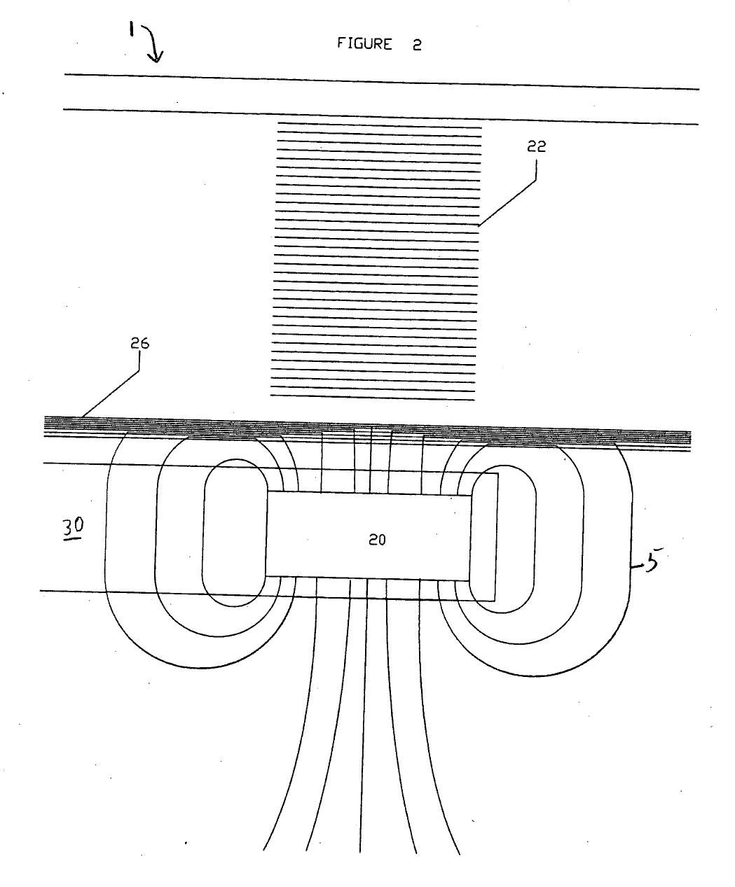

FIG. 2 is an enlarged partial view of generator 1 illustrating magnetic field/flux 5 of magnet 20 when the magnetic shield 26 is closed between the coil 22 and the magnet 20. This is referred to herein as a closed magnetic circuit. Preferably, the stationary magnet 20, including a permanent magnet, an electromagnet, a series of stationary magnets and electromagnets are located side by side. They are preferably arranged to be substantially equidistant from each other. In another embodiment, the magnets 20 are arranged so as to radiate around a center. In yet another embodiment, the magnets 20 are arranged in a more random pattern thus not being equidistant from each other. The magnet 20, is preferably bonded, in place by a non magnetically conducting material such as, but not limited to, a non austenitic metal, a non electrically conducting material including, but not limited to, glass, plastic, adhesives, ceramics, materials containing filler materials such as fibers, strands, mats, cloths, and composite laminations and/or combinations thereof.

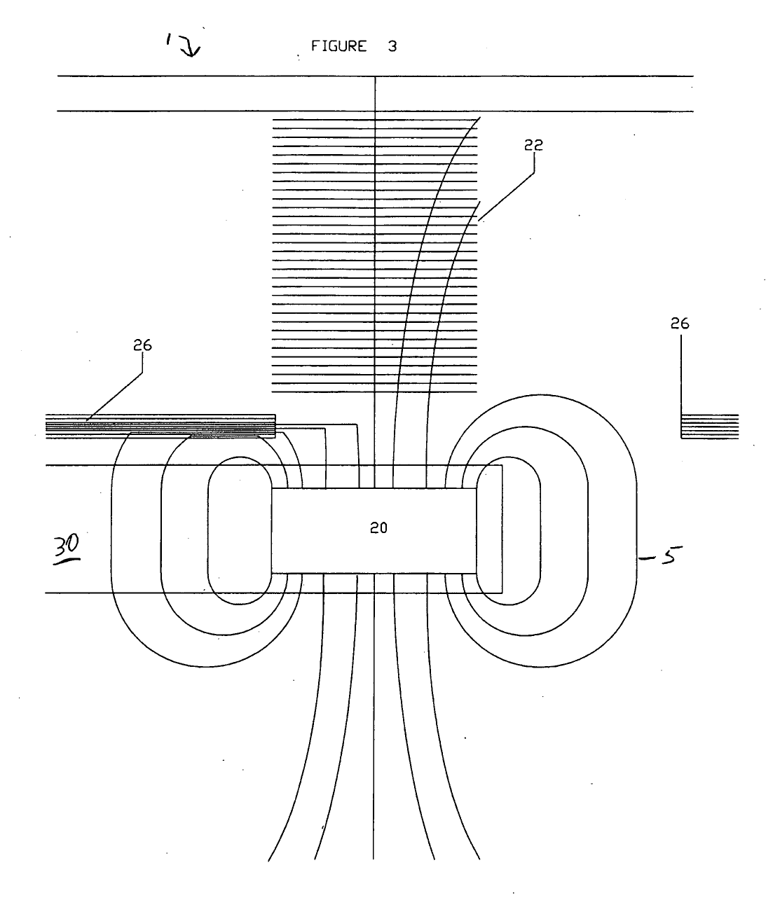

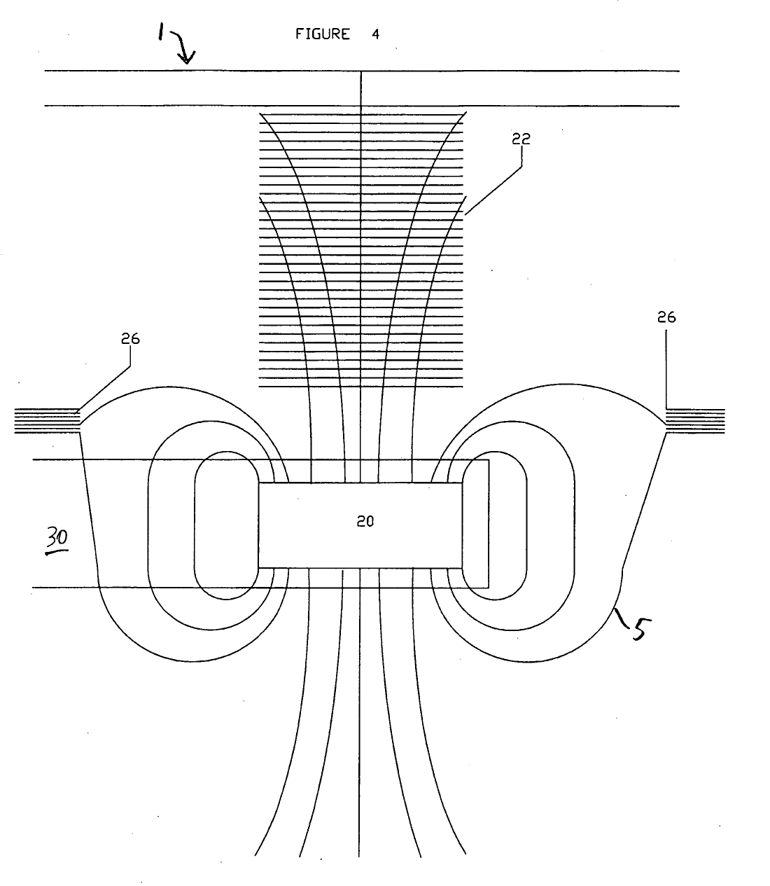

FIG. 3 is an enlarged partial view of generator 1 illustrating magnetic field/flux 5 of magnet 20 when the magnetic shield 26 is partially open between the coil 22 and the magnet 20. This is referred to herein as a partially open and partially closed magnetic circuit. FIG. 4 illustrates the magnetic shield in the fully open position and is referred to herein as an open magnetic circuit.

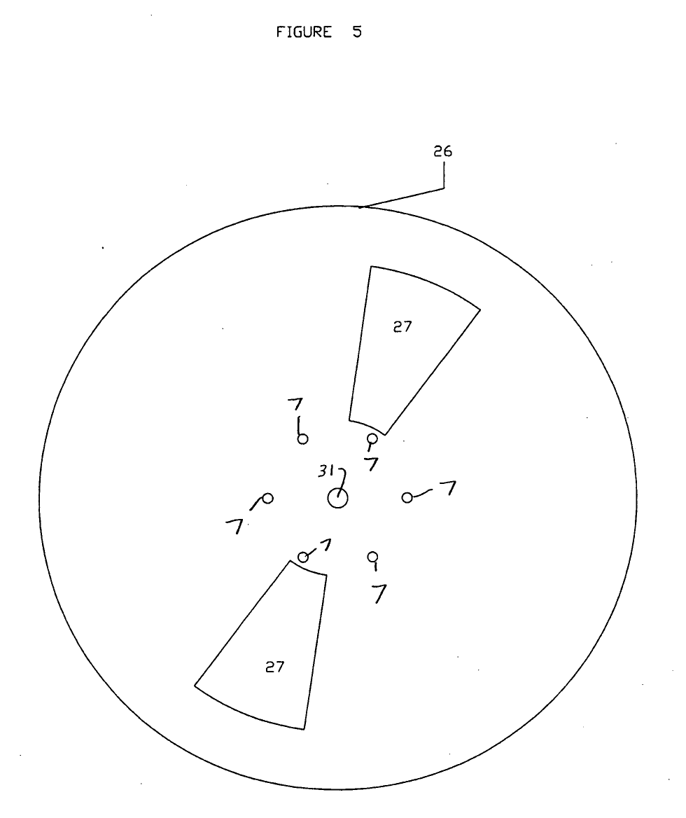

FIG. 5 illustrates a top view of the magnetic shield 26 showing two magnetic gateways 27. Preferably, the magnetic shield 26 is mechanically connected to axle 31. The connection may be with fasteners 7 such as illustrated in FIG. 5. The connection may also comprise a hub mounted on the axle 31 to facilitate the attachment of the magnetic shield 26. It should be understood that the connection, between the axle 31 and the shield 26, should be one that electrically isolates the shield 26 from the axle 31.

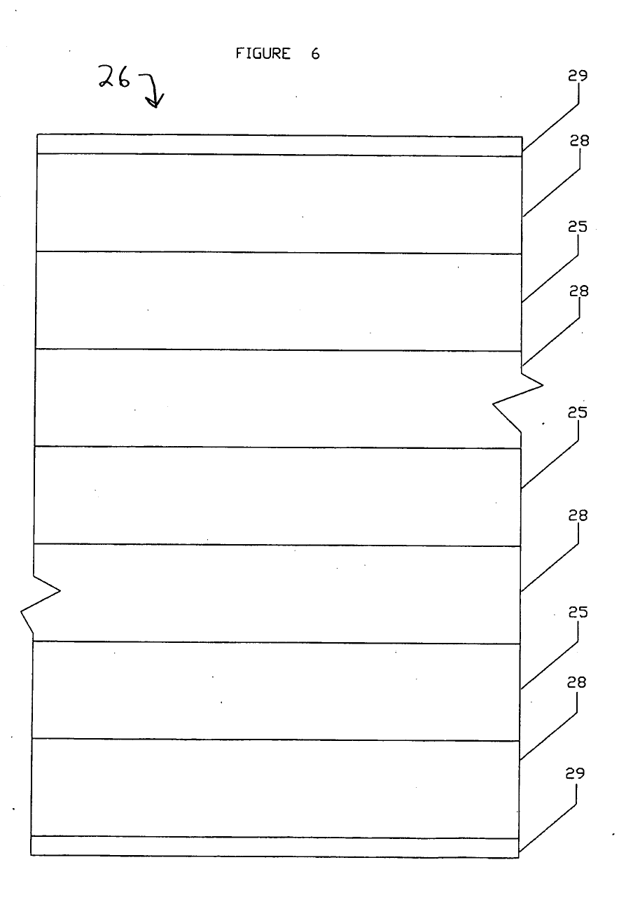

FIG. 6 illustrates a cross section of the magnetic shield 26 showing the various laminations which preferably make up the shield 26. Preferably the magnetic shield 26 is flat, shaped like a disk, and spins with and is attached to an axle 31. Preferably the magnetic shield 26 is comprised of one or more non electrically conducting and magnetically conducting or magnetically permeable materials 28 that have the ability to stop the magnetic flux of the magnet 20 from reaching the coil 22 and core 23. Preferably both sides of the shield are coated with a protective coating 29. A magnetically permeable material 28 is preferably below the protective coating 29. Preferably several layers of the magnetically permeable material 28 is sandwiched between the outer protective coating layers 29. Preferably, an adhesive material 25 is sandwiched between layers of the magnetically permeable material 28.

In one embodiment, the metallic layers of the magnetic shield 26 may be comprised of an iron metal alloy having Nickel (Ni) not less than 70 percent, Molybdenum (Mo) not less than 2 percent and Copper (Cu) not less than 0.05 percent. In another embodiment, the metallic layers of the magnetic shield 26 may be an iron metal alloy having Nickel (Ni) not less than 46 percent. In yet another embodiment the metallic layers of the magnetic shield 26 maybe an iron metal alloy having Iron (Fe) not less than 97 percent and Carbon (C) not more than 0.08 percent. In still another embodiment the metallic layers of the magnetic shield 26 may be a Silver containing metal alloy having Silver (Ag) not less than 97 percent. In yet another embodiment the metallic layers of the magnetic shield 26 may be a deposited aqueous solution containing various metals, in which Silver (Ag) comprises a range of not less than 0.001 percent solids and not more than 97 percent solids, Nickel (Ni) comprises a range of not less than 0.001 percent solids and not more than 97 percent solids, Copper (CU) comprising not less than 0.001 percent solids and not more than 97 percent solids, Carbon (C) comprises a range of not less than 0.001 percent solids and not more than 97 percent solids, Silver (Ag)comprises a range of not less than 0.001 percent solids and not more than 97 percent solids, and may contain one or more of the following elements: Bismuth (Bi), Carbon (C), Cerium (Ce), Dysprosium (Dy), Erbium (Er), Europium (Eu), Gadolinium (Gd), Holmium (Ho), Hydrogen (H), Iron (Fe), Lanthanum (La), Molybdenum (Mo), Neodymium (Nd), Niobium (Nb), Nitrogen (N), Oxygen (O), Phosphate (P), Potassium (K), Praseodymium (Pr), Promethium (Pm), Samarium (Sm), Sulfur (S), Terbium (Tb), Thulium (Tm), Tin (Sn), Titanium (Ti), Ytterbium (Yb), Yttrium (Y), Zinc (Zn), Zirconium (Zr), each of which may comprise a range of not less than 0.0001 percent solids and not more than 97 percent solids.

In another embodiment the metallic layers of the magnetic shield 26 may be comprised of an iron metal alloy having Nickel (Ni) not less than 70 percent, Molybdenum (Mo) comprising less than 5 percent, and Copper (Cu) comprising not less than 1 percent. It should be understood that any other highly magnetically conductive material known as a highly magnetically permeable or magnetically conductive material may be utilized for the metallic layers of the magnetic shield 26. In another embodiment, the magnetic shield 26 may be composed of one or more of the materials discussed hereinabove and is laminated with a plastic based adhesive that cures at less than 300 degrees C. and preferably has a shear strength less than 27 KSI and has a very high electrical resistance value.

Preferably, the magnetic shield 26 layers are in a thickness range of not less than 2 nanometers thick and not more than 10 mm. Further, the magnetic shield 26 layers are treated and allowed to substantially develop desired characteristic properties prior to lamination. In one embodiment the magnetic shield 26 layers may be treated by metal, such as Silver (Ag) in nanometer particles thereby increasing their effectiveness. In another embodiment, the magnetic shield 26 layers may be treated an aqueous metal solution, as described hereinabove, in nanometer thicknesses, thereby, increasing their effectiveness.

Preferably, the magnetic shield 26 metals are arranged so as to substantially prevent the metal layers from directly contacting any other metal layer and are separated by a layer of an adhesive plastic material. Preferably, the adhesive layer 25 is in a thickness range of at least 2 nanometers to under 10 mm.

Preferably, magnetic gateways 27 substantially match the shape of the magnet 20. In one embodiment the magnetic gateways are open. In another embodiment, the gateways 27 may be filled with a magnetically indifferent material such as, but not limited, plastic, glass, organic material, filler, fiber, ceramic matrixes or combinations thereof. In yet another embodiment, the magnetic shield 26 operates with the gateways 27 filled, as described hereinabove in solid and the shield 26 being coated in a plastic layer 29 with characteristics similar to that of Teflon.

It has been discovered that the magnetic shield 26 is provided with a preferred operation (i.e. smoother operation), when the magnetic shield 26 when the gateway 27 are shaped substantially identical to the shape of the magnet 20 and providing that the entire face of a magnet 20 is revealed. In one embodiment, the gateway 27 has a length and width range of more than 1% greater than the length and width of the magnet 20 and less than 101% greater than the length and width of the magnet 26.

In another embodiment, the magnetic shield 26 operation is preferably achieved when the magnetic shield 26 includes more than one layer of materials as defined hereinabove and that material is sandwiched or alternated in layers with non magnetic and non electrically conducting materials that act as adhesives, cementing the other layers together, and such adhesives are placed wet or uncured in a layer preferably exceeding 2 nanometers in thickness. In another embodiment the magnetic shield 26 includes more than one layer of the materials as defined hereinabove and a silver containing metal alloy, with silver comprising not less than 97 percent, is applied to a metal layer of the magnetic shield which contains less than 1 percent Molybdenum (MO). In another embodiment, the magnetic shield 26 includes more than one layer of materials as defined hereinabove and the material having Iron (Fe) not less than 97 percent and Carbon (C) not more than 0.08 percent is not used. In yet another embodiment, the magnetic shield 26 includes more than one layer of materials as defined hereinabove and the material having Iron (Fe) not less than 97 percent and Carbon (C) not more than 0.08 percent is used on the layer furthest from the magnets. In still another embodiment, the magnetic shield 26 includes more than one layer of materials as defined hereinabove and is used in conjunction with the material having Iron (Fe) not less than 97 percent and Carbon (C) not more than 0.08 percent. In this embodiment, shield 26 operates for a longer period without oxidation if another material is used to encapsulate the iron containing material to prevent any exposure thereof to air.

In still another embodiment, the amount of electricity produced, by the coils 22, is greater when the magnetic shield 26 material, as defined hereinabove, is formed in flat layers and the thickness for any material layer does not exceeds 10 mm. In still another embodiment, the amount of electricity produced, by the coils 22, is greater when the magnetic shield 26 material, as defined hereinabove, is formed in flat layers and the thickness for any material layer is not less than 2 nanometers.

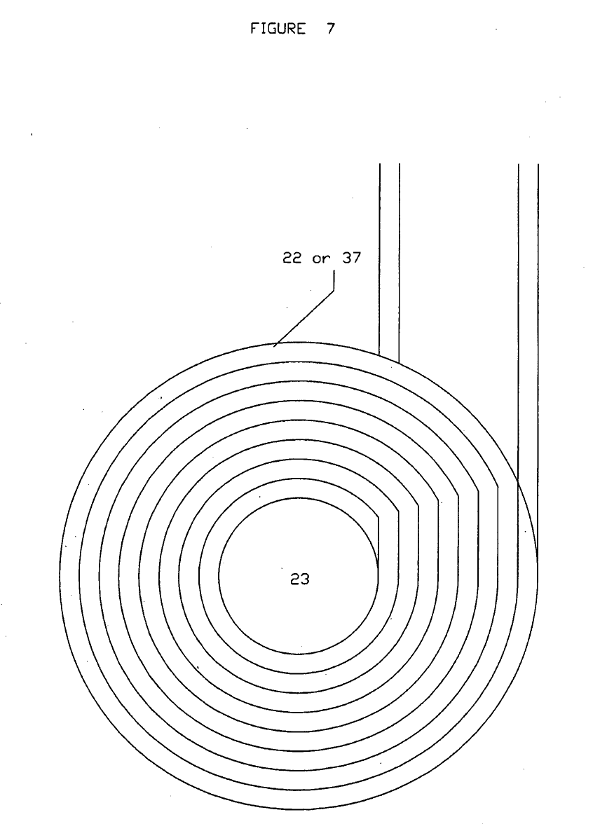

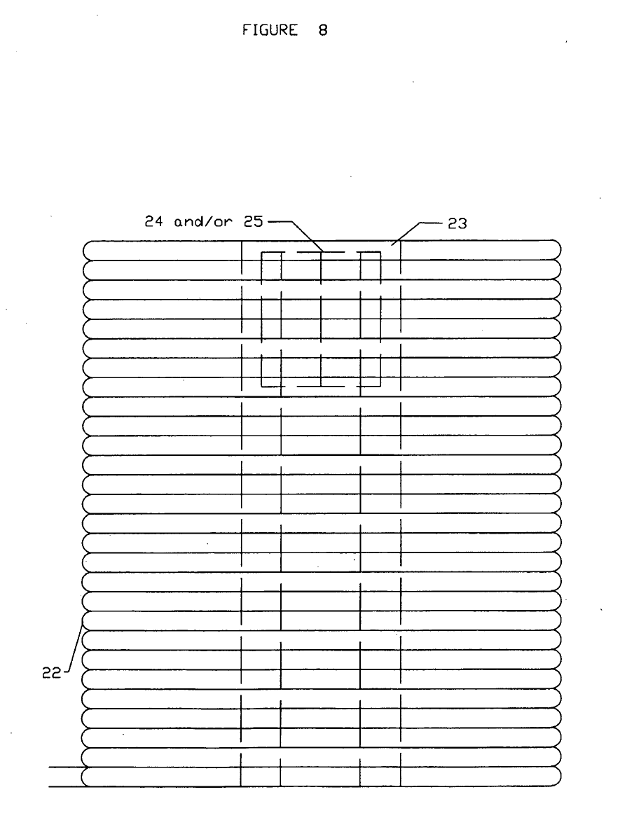

Referring now to FIGS. 7 and 8, there is illustrated a top view and a side view of a conductor coil 22. The stationary coil 22 is preferably formed from a conductor including copper with an electrical insulation coating made with a highly electrically resistive material, such as one including an AlN (Aluminum Nitride) matrix, resins, polymers, or other plastics, coating the conductor. Preferably, the coating thickness is in a range of approximately 0.01 mm to more than 1.0 mm. Preferably, the conductor is wound around a core 23. Preferably, the stationary core 23 sits directly adjacent to the stationary magnet 20 and is separated by a distance in a range of not less than 0.01 mm and not more than 205 mm.

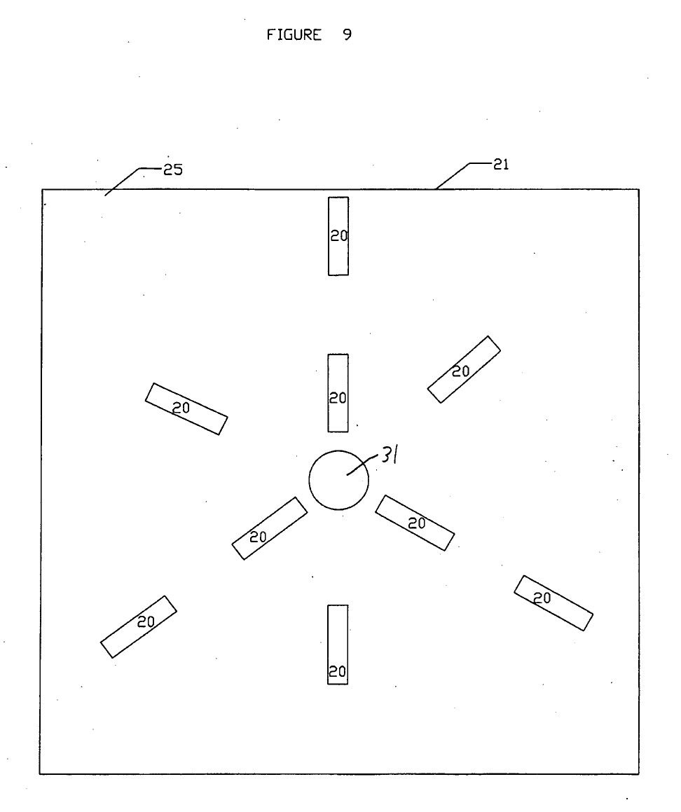

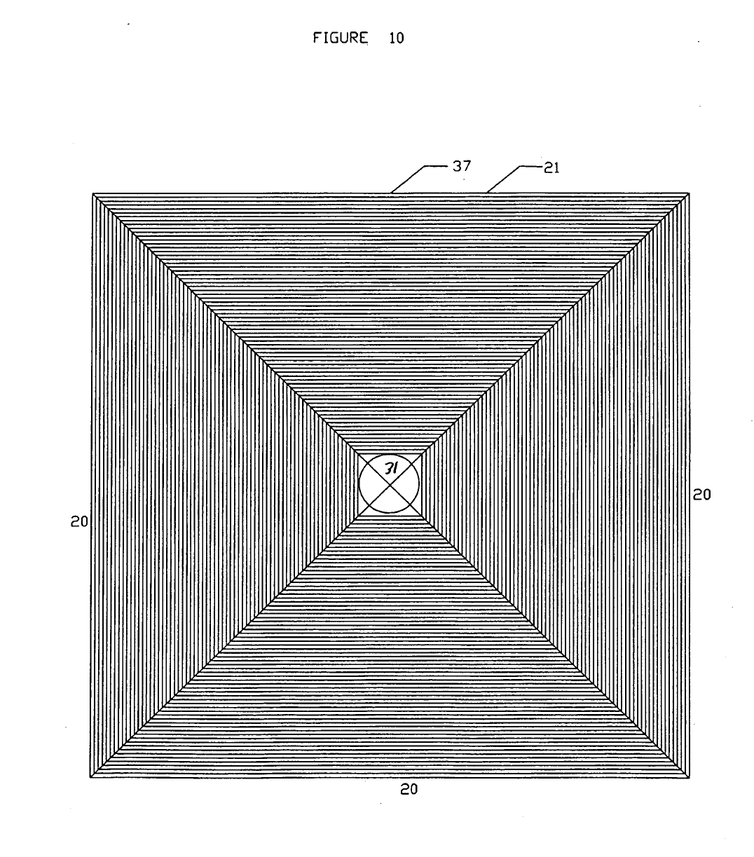

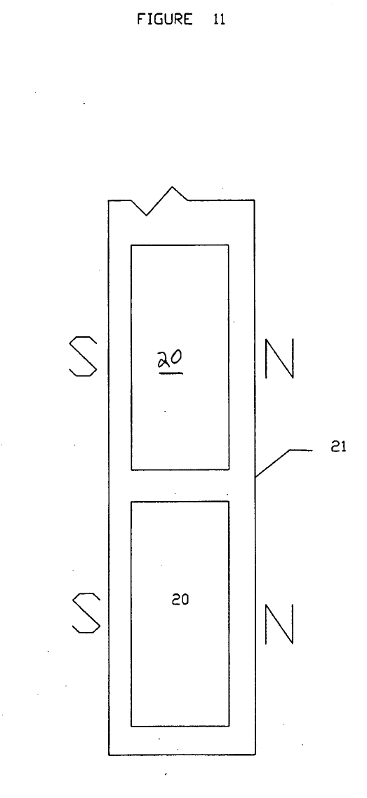

Preferably, core 23 contains both iron (Fe) and non iron containing material. These materials are amorphous and preferably separated electronically and magnetically into free spinning molecules. Thus, the core 23 is magnetically oriented when a magnetic field is present and is randomly oriented when a magnetic field is absent. The core 23 is preferably secured to a backing material which serves as a structural member of the core 23. The core may be attached, to the backing, using a mechanical fastener or fasteners 24. The mechanical fastener may be of a material such as, but not limited to, a non austenitic metal, a non electrically conducting material including, but not limited to, glass, plastic, ceramics, materials containing fillers such as, but not limited to, fibers, strands, mats, and cloths, or composite laminations and/or combinations thereof. It should be understood, that other methods of attachment, such as, but not limited to, adhesives can also be utilized. The type of fastener or method of attachment should not be viewed as a limitation herein. However, the non-magnetically conducting properties of the fastener or other attachment member is highly desirable. Referring now to FIGS. 9, 10, and 11, there is illustrated a side view of the magnetic plate 21. Specifically, FIG. 9 illustrates the magnetic plate 21 when used in conjunction with a permanent magnet and FIG. 10 illustrates the magnetic plate 21 when used in conjunction with an electro-magnet. FIG. 11 illustrates an end view of the magnetic plate 21. The magnetic plate 21 is a stationary plate. In one embodiment, magnetic plate 21 has at least one permanent magnet 20 mounted thereon (FIG. 9). In another embodiment, magnetic plate 21 has least one electro-magnet 37 mounted thereon (FIG. 10). The electromagnets are continuously energized or may be pulsed with energy. In one embodiment, the magnetic plate 21 is comprised of permanent magnets 20 with the polarity of the magnets 20 facing towards the outside two faces of the plate. In another embodiment, each permanent magnet 20 has the center of the magnet's polarity substantially centered in the middle of the largest face of the magnet 20. In an embodiment utilizing an electro-magnet, the electro-magnets remain charged and polarized so as to face towards the outside two faces of the plate 21. In another embodiment utilizing an electro-magnet, the electro-magnets in the magnetic plate 21 are oriented at substantially 90 degrees to the coils 21. Preferably, the permanent magnetic plate has the magnets 20 charged to have a homogeneous polarity facing each way out from the plate surface.

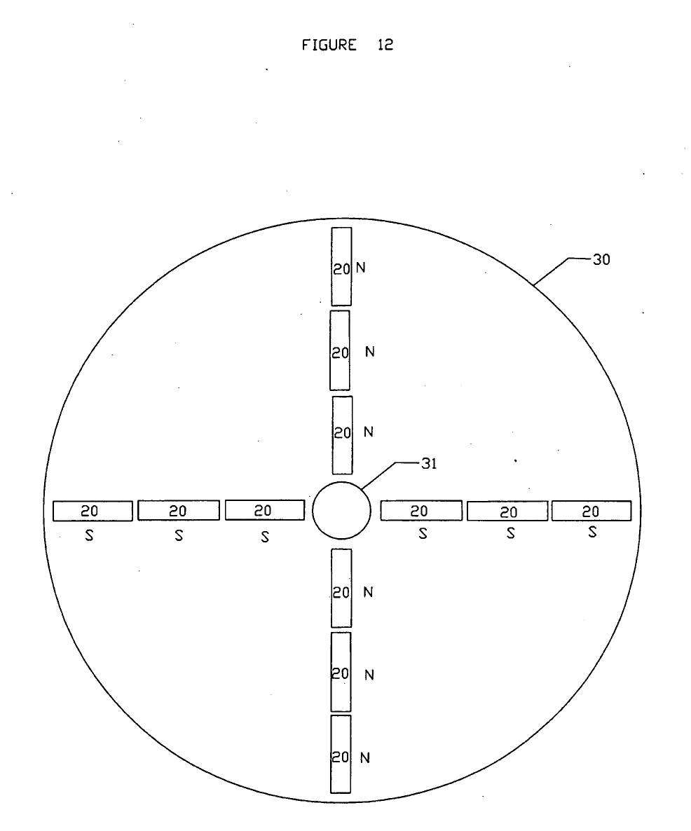

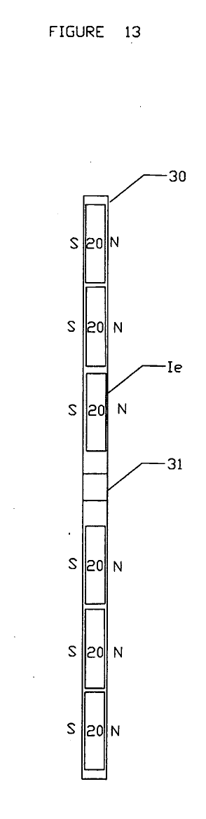

Referring now to FIGS. 12 and 13, there is illustrated a side view and end view of a magnetic motor disk 30. As described herein, disk 30 spins the magnets 20 in the motor. Preferably, the disk 30 formed from materials such as, but not limited to, a non austenitic metal, a non electrically conducting material including, but not limited to, glass, plastic, ceramics, materials containing fillers such as, but not limited to, fibers, strands, mats, and cloths, or composite laminations and/or combinations thereof. Preferably, the disk material is not electrically or magnetically conductive. In another embodiment, an even number of magnets 20 are mounted to disk 30. In yet another embodiment, the magnets 20 have alternating polarity, with the first having a north pole on the left face of the disk 30, the next magnet 20 having a south pole on the left face of the disk 30, the third having a north pole on the left face of the disk 30 and continuing all the way around the face of the disk 30. In another embodiment, the magnets 20 are spaced apart at least with a space between the magnets 20 being in a range of not less than the width or diameter of the magnet and not further than twenty times the width or diameter of the magnet 20.

In an embodiment utilizing an electro-magnet 37 or a series of electro-magnets 37 are placed on both sides of the spinning disk 30 and mounted on the structural wall. In another embodiment utilizing an electro-magnet 37, the electro-magnet 37 is activated to equal the polarity of a passing magnet. In yet another embodiment, the electro-magnet 37 is shaped flat on the surface closest to the rotating disk and matches the shape of the magnets on the rotating disk 30. In operation, the electro-magnet 37, when activated just prior to the arrival of the center of the permanent magnet 20 to the center of the electro-magnet 37, propels the spinning disk 30 forward with a repulsing action. The electro-magnet 37 gets de-energized as the magnet 20 on the rotating disk 30 passes it. Preferably, the electro-magnet 37 is activated by a DC current from a battery source and is activated for under twenty milliseconds. It should be understood that the proper thickness and length of conductor coupled with the proper voltage allows the coil 22 to fully charge in less than twenty milliseconds. In one embodiment, the charging time is substantially close to one millisecond.

The variable speed permanent magnet/electro-magnet motor 3 is more efficient when the electromagnets 37 are operated by a sensor circuit that is set to activate the electro-magnet 37 prior to the arrival of the permanent magnet 20 spinning on the disk 30 approximately one to fifteen degrees prior to the alignment of the centers of the spinning permanent magnet 20 with the stationary electro-magnet 37, with the advance dependant upon the speed of the motor. A back emf charge is created by the electro-magnet 37 upon de-energization within the conductor. The back emf can be placed back into a battery or into some other circuit but can not be allowed to remain in the conductor. The battery, if it receives the back emf, may overcharge at operating conditions where pulses are kept under twenty milliseconds. It should be appreciated that the possibility of overcharging preferably require periodic or ongoing discharging. Preferably a regulator circuit is utilized to maintain a stable battery charge. This regulatory circuit may release the excess power to another circuit such as, but not limited to lighting or to ground. In one embodiment, the electro-magnets 37 are of a different number than the even numbered permanent magnets 20 which are preferably paired on the disk 30. It should be appreciated that magnetic shielding may be used to enclose the electro-magnets 37 on the five sides not facing the disk 30.

FIG. 14 illustrates a side view of a structural wall of the motor further illustrating the cooling system utilized to cool the coil 22 and/or the bus bar 33. The cooling system preferably utilizes internally grooved copper tubes with circulating refrigerant, which may be placed in desired locations including the bus bar 33 and the conductor within the coil 22. The cooling system may surround the bus bar 33 both internally and externally. In one embodiment, the cooling system is placed into its final location, within the copper form and filled with molten cast copper, sealing the copper tubing within the copper bus bar 33. In another embodiment, the cooling system may use power, generated by the motor 3, to operate a compressor to remove the heat. It has been discovered that when the cooling system maintains the optimal internal operating temperature, which is preferably below the freezing point of water, there is a 5% change in power output with every 8 degree C. change in temperature. The cooling system may not be not necessary for the operation at temperatures of between 48 C and −52 C. However, the cooling system is preferred for greater efficiency and greater output. The cooling system may utilize a compressed gas such as an ecologically safe carbon based gas and can be adapted for a scroll type or centrifugal compressor. The cooling system preferably provides an electrical break in the lines through a plastic or ceramic composite coupling having high dielectric properties and universal joint utilizing such materials as ABS and fiber. This allows the cooling gas to pass and the electricity to remain within the generator 1 without energizing the compressor. The copper alloy used in the copper tubing may contain Phosphate (P) in minimum quantities sufficient to allow a malleable copper alloy thus providing ease of drawing of the alloy through dies. The phosphate impurity is within acceptable ranges and provides for the copper to retain no less than 98% of its electrical conductive capacity compared to the electrical conductivity capacity of pure copper. The use of conventional amounts of phosphate (P) in the copper for drawing ease causes significant reduction in electricity production and should not be used on any electrical element of the system.

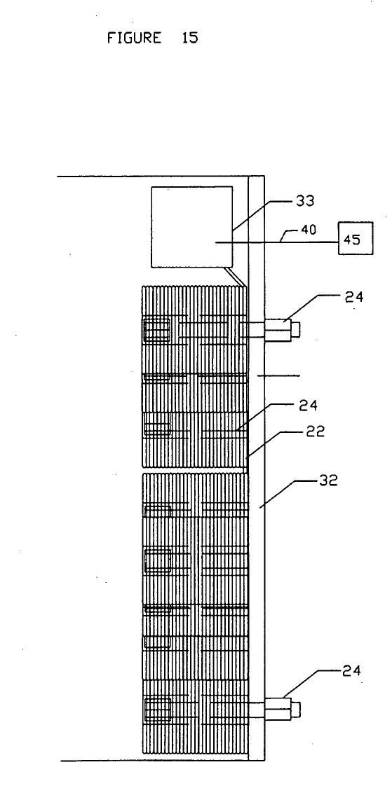

FIG. 15 illustrates a end view of the structural wall of motor 3. In this embodiment, coils 22 are attached to the enclosure 32 utilizing fastener 24. Preferably, fastener 24 is a non magnetically conducting fastener. It should be appreciated that other methods of attachment can be utilized.

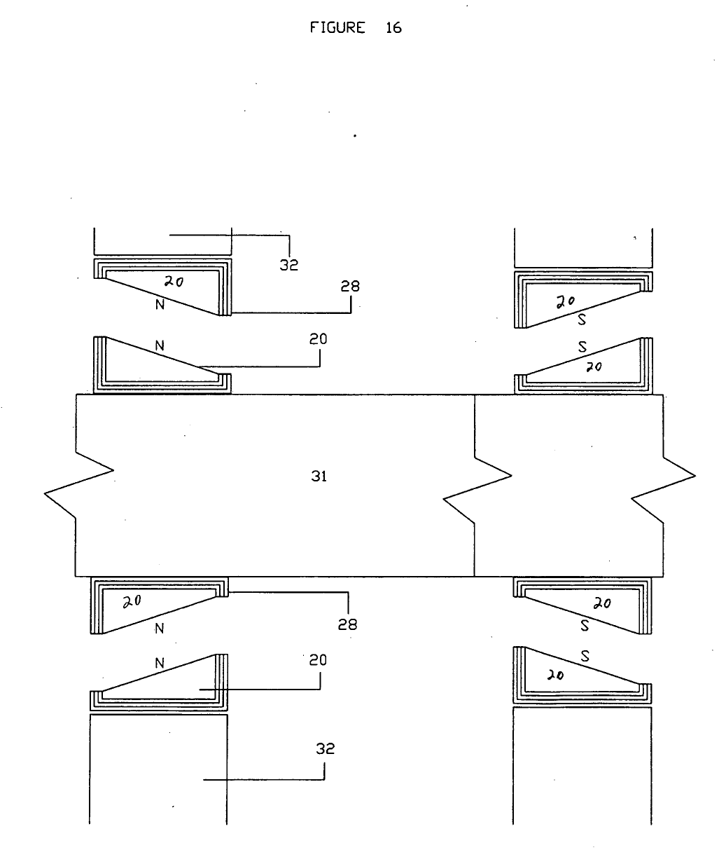

FIG. 16 illustrates magnetic bearings for the axle 31. Preferably, the magnetic bearing 9 is conical in shape and is made of two components. The magnetic bearing 9 may have a case made from a magnetically permeable material and filled with a magnetic material such as NdFeB sintered magnetic material. The conical shape may be of a size such that one side is taller or wider than the other side by double the distance of the gap between the two magnets. Preferably, the magnetic bearing operates with an air gap between the two cones exceeding approximately 1 mm between the two cones. Since the parts do not contact, the magnetic bearing 9 operates substantially without friction. The inside cone sits upon and is attached on the axle 31 and the outside cone sits upon and is attached to the stationary frame. The magnetic bearing 9 may be polarized such that both parts have north or south poles adjacent to each other. Preferably, the magnetic bearings 9 are set with the cones facing each other or away from each other providing equal force of repulsion along the axle 31.

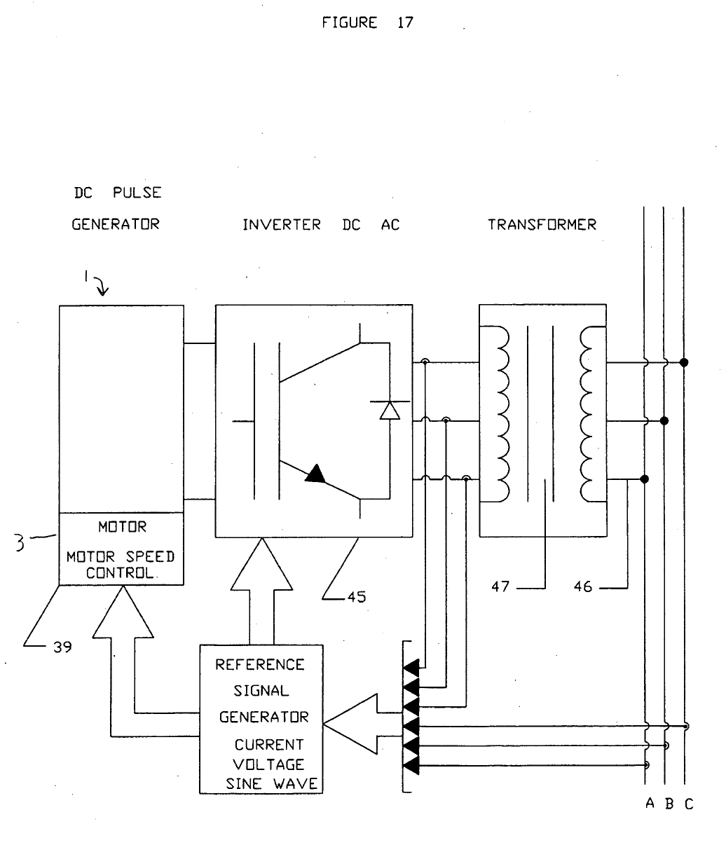

FIG. 17 illustrates an electrical circuit of the generator. The inverter 45 converts the current of the bus bar 33 into the current normally utilized by a conventional power grid, typically either 50 Hz, 60 Hz, or 400 Hz. An alternative method for inverting the power is having the DC pulse generator's output DC power drive a DC power motor attached to a conventional AC current generator.

FIG. 18 illustrates an electrical circuit of the motor. Preferably, a magnetic sensor or sensors 36 are placed between the electromagnets 37 on both sides of disk 30. The magnetic sensor 36, typically attached to the enclosure 32, connects to a control circuit or circuits that operate the electro-magnets and the speed of the motor. The magnetic sensors 36 preferably controls the firing of the electro-magnet 37 as the permanent magnet is approaching the electro-magnet.

FIG. 19 illustrates an analysis of the output wave data from the generator 1. As illustrated, in this embodiment, the DC pulse is converted to AC power through a conventional inverter 45. It should be understood that other methods of conversion may be utilized. The inverted power can be further refined through a transformer 47 or a series of transformers and/or other devices. This allows the electrical power to be used by a consumer or consuming device.

### Operation

The generator 1 works on a principle of the disturbance of the magnetic field 5 within the coil 22. The coil 22 is repeatedly exposed to fluctuating levels of magnetism. That magnetism is of the same polarity as the permanent magnet polarity. As the magnetic shield 26 operates between the magnet 20 and coil 22, the intensity of the magnetic field in the coil 22 alternatively increases and decreases. This change or disturbance of the magnetic flux in the coil conductor causes electricity to flow.

Effectively, the generator 1 moves the magnetic pole along a magnetic circuit. When a coil 22 is placed within a break in the magnetic circuit, the magnetic flux 5 (see FIG. 2) energizes the coil 22 and electricity is produced. This break in the magnetic circuit is called a magnetic gateway 27, which opens like a doorway allowing a magnetic flux 5 wave to leave the closed magnetic circuit and radiate into the coil 22 as seen in FIGS. 3 and 4. The coil 22 gains energy from the point that the magnetic gateway 27 opens until the magnetic gateway 27 closes. This magnetic energy and the corresponding electrical energy peaks in intensity when the magnetic gateway 27 opens totally and then decreases in intensity as the magnetic gateway 27 is closing. When the gateway 27 is fully closed the current inside the coil 22 drops to near zero, with a residual remaining period of partial energization. Specifically a magnetic shield 26 that has non magnetically shielding openings 27 in it moves or spins and creates a disruption in the magnetic field 5 within the conductor coils 22 which causes electricity to flow. Optimally the non magnetically shielding openings 27 are at least two times the size of the magnet 20 and are shaped like the magnet in motion. For example, not intending as limiting, a square magnet 20 would have a non magnetically shielding opening that has a straight edge with the edge close to being parallel to the face of the magnet.

The motor 3, in practice, appears to move a magnetic pole around a closed path, never approaching another magnet. By placing magnets 20 of opposite polarity alternately along the face of a rotor or disk 30, the magnetic flux lines would join from each of the opposing and adjacent magnets. By keeping the magnets 20 as illustrated in FIG. 12 on the rotor or disk 30 an even number, and the electromagnets 37 a different number as illustrated in FIG. 14, there would never be any alignment of magnets on the electromagnets that are pulsing with the same polarity as the magnets 20 on the rotor 30, propelling it forward. As the magnet 20 approaches an electro-magnetic coil 37, the electro-magnetic coil 37 is neutral in polarity with no repelling action so that there is no drag to the rotational force. As the magnet 20 starts to leave the electromagnetic coil 37, the electro-magnetic coil 37 is energized and reaches maximum polarity that matches the polarity of the passing permanent magnet 20, forcing the magnet 20 away from the electromagnetic core coil. As the electromagnetic core coil is de-energized, and its magnetic field is collapsing, then the next approaching magnet 20 of the disk 30, having the opposite polarity, is drawn to that collapsing magnetic field, accelerating, as opposite magnetic poles attract. As the next magnet 20 arrives to the electro-magnet 37, the magnetic sensor 36 (see FIG. 18) activates the current in the electro-magnet and forces the now nearly aligned magnet 20 to be repelled with the same polarity. This pulsing has to occur at no longer than a 20-millisecond interval and is long enough to energize the coil to be an effective electro-magnet 37.

When the disk 30 is operating faster than the electro-magnet 37 can charge itself, then the electro-magnets 37 fire less often, skipping the opposite polarity operation, and they fire out further along the radius of the disk 30 than when the disk 30 is operating at a slower speed. This is similar to the operation of gears in a transmission. Inside diameter electro-magnets 37 are activated for slower speeds and the outside electro-magnets 37 are activated for faster speeds with maximum energy being produced. This ability to control the speed based on the electrical demand is unique to this technology and is its essential element.

In a further embodiment, the motor 3, may further comprise utilization of the passing magnetic fields to generate electricity by placing coils 22 along the entire face of the structural wall 32 as illustrated in FIG. 14, except where the electro-magnets 37 and magnetic sensors 36 are located. This electricity has a square wave characteristic that varies around a DC reference level. This electricity powers, in part, the battery that creates the initial pulse to activate the electro-magnets 37 of the motor 3. Finally, the internal controls comprise the switching circuit that turns the electro-magnet coils 37 on and off at the appropriate times, as illustrated in FIG. 18. This is necessary in order to redirect any back emf from the conductor and to re-channel it into the proper direction of the current flow, eliminating any potential eddy current in the conductor. This prevents the buildup of resistive magnetic forces that oppose the motor 3 through back emf and creates vibration and reduces the motor's 3 output. This switching circuit uses a power MOSFET, a transistor, a diode, and/or similar technology, based on the speed of the operation, and the power and alignment of the electronic circuitry. This gives the DC pulse generator virtually zero rotor drag, and virtually all of the magnetic and motive force is turned directly into usable electrical energy.

The coil 22 or a number of such coils 22 are preferably attached to a structural wall 32 between the sensors 36 and electro-magnets 37 to both sides of the spinning disk 30. A current produced by the coil 22 in the motor 3 is different from that in the generator 1 and is more of a square wave rather than a half sine wave and is easily converted to DC through a diode. Preferably, the diode or diodes are mounted on a separate copper plate cooled with grooved pipes preferably filled with circulating refrigerant. Preferably, the produced current is directed, at least in part, to the battery and, if desired, other instruments and general lighting. The remaining power is directed to the inverter (or other power converting equipment) as is the output produced by the generator 1.

Preferably, the variable speed permanent magnet/electro-magnet motor 3 produces enough torque to spin itself, the axle 31 and the attached magnetic shield 26 of the generator 1. Further, the variable speed permanent magnet/electro-magnet motor 3 can be utilized in a system wherein the motor 3 is combined with the generator 1 and can be mounted in various positions on the axle 31. Further, the motor 3 can be sized according to the weight of the entire turned mass and can be regulated according to the total speed that the generator 1 needs to operate under a particular demand load by adjusting the sequence and length of the electro-magnetic energization. Preferably, an electric circuit controls the operation of the motor 3 and may utilize a computer chip circuit to control the electric circuit which controls the firing of the motor 3. Preferably, the electric circuit will have a built in redundancy by having one or more alternate firing circuits operating. Preferably, the control electric circuit is shielded from the rotating magnetic field in the generator 1 with a magnetic shield as described.

Preferably, the permanent magnets 22, mounted in the disk 30, are arranged so as to be radiating from the center and one or more rows are used. The permanent magnets 22, when repulsed by the electro-magnets 37 and are energized with the same polarity, become the motive/rotational force for the motor 3. The magnets 22, when energized and repulsed by the electro-magnets 37, are mounted onto the rotating disk 30 in such a way as to control the speed by arranging the electro-magnet firing on every magnet 22 or on every second magnet 22 depending the required speed and on the innermost ring of magnets 22 for slower speeds, the next innermost ring for faster speeds and the outermost ring for the fastests peed.

Preferably, the motor's electronic circuitry is shielded from the rotating magnetic field in the motor 3 with a magnetic shield. The amount of electricity produced by the coils 22 is greater when the motor 3 and DC pulse generator 1 are operating electronically independent of each other and connected together just with the axle 31. The amount of electricity produced by the coils 22 is also greater when the motor 3 has the back spike of emf, that is produced by the collapsing electro-magnetic field in the electro-magnets, directed in part to the battery and in part through diodes into the output current of the DC pulse generator. Further, the amount of electricity produced by the coils 22 is greater when the motor 3 achieves faster speeds when the electro-magnets 37 are energized in alternating order, skipping every second electro-magnet 37. Still further, the amount of electricity produced by the coils 22 is greater when the motor 3 achieves faster speeds when the electro-magnets 37 are energized in alternating order, skipping every second electro-magnet 37 and operate in the same polarity. It should be understood that the speed of the operation of the motor 3 is directly tied to the speed of the spinning disk 30. The speed of the operation of the motor 3 is further tied to the opening or energizing the coil 22 with electricity and the closing or turning off the electric current to the electro-magnetic coil that pulse the disk 30 forward. Still further, the speed of the operation of the motor is tied to the speed the electro-magnets increase their electro-magnetism and collapse their electro-magnetic fields. In still another embodiment, the amount of electricity produced by the coils 22 is greater when the motor disk 30 is configured with one or more rows of magnets 20 radiating from the center, of the disk 30, in one or more rings positioned at different diameters from the center. In this embodiment, the motor 3 achieves faster speeds when the electro-magnets 37, located at a larger diameter ring are energized. Further, the motor 3 is easier to begin rotation when more than one electro-magnet 37 is energized from more than one ring.

In another embodiment, the amount of electricity produced by the coils 22 is greater when the space between the electro-magnets 37 in the motor 3 is filled with coils 22 and said coils 22 are wired to two separate bus bars 33. In another embodiment, the amount of electricity produced by the coils 22 is greater when the motor 3 has the paired electro-magnets 37 acting in unison pulsing at the same time and with polarities that match the face of the magnet 20 that faces the electro-magnet 37. In still another embodiment, the amount of electricity produced by the coils 22 is when the said motor's electro-magnet 37 is activated to equal the polarity of a passing magnet 20. In another embodiment, the motor 3 is more efficient when the electro-magnets 37 are paired up and operated on opposite sides of the same rotating permanent magnet 20 that rotates on the disk 30, and operate at the same time. Thus. It should be understood that the current produced by the DC pulse generator 1 is dependent upon the speed of rotation, the number of openings 27 in the magnetic shield 26, the number and strength of the permanent magnets 20, the speed at which the electro-magnets 37 reach their maximum polarity and design of the coils 22. It has been found that, for example and not intending to be limiting, in a bus bar 33 powered by 114 coils 22 and 57 magnets 20 and operating at 4200 rpm, produced over 20,000 electro-magnetic moments per second and electric waves that went from 0 to a peak and back to 0 which in effect create a practical DC wave. The current, if isolated into single waves, has a curved V form which originated at close to 0 and went to a peak and then down to zero, with the top peak being rounded and closer to a U rather than a V but with steep V sides. The current has a peak for approximately ⅕ to ⅙ of the time between the beginning of the DC pulse and the beginning of the next DC pulse and during the remaining balance of the time, the current is approaching zero or increasing from zero. The current is most effective when there are as many as possible unique magnetic moments and electro-magnetic moments. A magnetic moment is a peaking of a magnetic wave and the period of the most intense magnetic flux with a lower intensity at both ends and a higher intensity right in the middle. The magnetic gateway 27, by opening and closing the magnetic flux, creates the magnetic moments. An electro-magnetic moment is the conversion of a magnetic moment into useful electric current and is the useful portion of a magnetically induced electric surge.

The motor 3 produces an individual current that is alternating and is square in shape while the generator 1 produces an individual current that is V shaped with a period of time that the coil 22 is not energized having a current approaching a zero baseline. The DC pulse generator 1 produces a current that when combined from all coils 22, having the same polarity, has more than two peaks that join together to produce a DC current. Further, the DC pulse generator 1 produces an individual current that is a high frequency AC shaped current. The DC pulse generator 1 produces a current that is of highest quality when 1) no two magnetic moments peak at the same time on a given bus bar 33; or 2) when two or more bus bars 33 of the same polarity are tied together electronically. It has been found that the generator 1 produced usable current that when used in its raw unconditioned form produces large amounts of hydrogen and oxygen in its mono atomic and diatomic configuration, depending on the presence of certain catalysts including lye, from the electrolysis of water. Further, the generator 1 produces an individual current that is V shaped and is rounded on the extreme tip in shape with a period of time that the coil 22 is not energized having a current approaching a zero baseline.

The variable speed motor 3 produces electricity that has a square wave that is easily converted to a DC current. The variable speed motor 3, when combined with the DC pulse generator 1, produces electricity. In this embodiment the electrical output is not related directly to the amount of electricity used to operate the motive source of the apparatus, is not related directly to the amount of electricity used to operate the apparatus by moving the magnetic shielding material, and is not related directly to the thickness of the magnet. However, the electrical output is related directly to the shielding ability of the magnetic shield 26, is related directly to the shape of the magnet 20, is related directly to the shape of the magnetic gateway 27, is related directly to the shape of the coil 22, is related directly to the style of the coil 22, is related directly to the size of the coil 22, is related directly to the composition of the core 23 of the coil 22, is related directly to the temperature of the core 23 and coil 22, is related directly to the temperature of the bus bar 33, is related directly to the speed of the opening and closing of the magnetic gateway 27, is related directly to the strength or magnetism or magnetic flux density of the magnets 20, is related directly to the orientation of the magnetic field, and is related directly to the distance of the permanent magnet 20 from the coil 22. Further, the electrical output is optimized when the size of the coil 22 and magnetic gateway 27 is greater than the size of the permanent magnet 20, is maximized when the magnetic field's pole center is lined up with the center of the magnetic gateway 27, is optimized when the magnetic plate 21 is located between two magnetic shields 26 with magnetic gateways 27, is optimized when the shapes of the magnet 20, coil 22, and magnetic gateway 27 are substantially the same, and is optimized in the embodiment that uses an electro-magnetic plate when the electro-magnets 37 are wound or lined up in the same plane and are oriented at 90 degrees to the coils 22 that produce electricity.

### EXAMPLES

The following examples are of qualitative data obtained during a variety of tests. It was noted that the data clearly indicates that there is a direct relationship between the temperature and the output of the generator. The relationship is that for approximately every 8 degree C. change in temperature, there is a corresponding change of 5% in power output. This is more likely related to the resistance of copper which was used as a conductor. Further the data indicates that the largest determiner of power output is the number of coils and magnets. The speed of rotation of the generator was a less direct determiner of power output. The DC pulse generator invention acts like a magnetic power cell, pumping electricity out of the magnetic flux found in permanent magnets.
Design A:
Test 1
Bus Bar Power Output for Design A (This Bus Bar is powered by one power lead (2 total leads) from 62 coils and uses 31 magnets and the speed of magnetic shield rotation is 4200 RPM, operating horizontally)
Exterior Ambient Temperature: 48.0 C
Average Temperature of Coil Cores: 46.6 C
Average Temperature of Bus Bars: 49.8 C
Test After Reaching Ambient Temperature for: 30 Minutes
Bus Bar Power Output:
Actual Output per bus bar in Hertz: 12,460 half cycles/second
Output Individual Wave Shape: parabolic U shape
Output Combined Effective Hertz: Direct Current (DC)
Voltage (to transformer/inverter): 12.9V
Amperage (to transformer/inverter): 7,852 A
Wattage computed at bus bar: 101,294 W
Test 2
Bus Bar Power Output for Design A (This Bus Bar is powered by one power lead (2 total leads) from 62 coils and uses 31 magnets and the speed of magnetic shield rotation is 4200 RPM, operating horizontally)
Exterior Ambient Temperature: −27.0 C
Average Temperature of Coil Cores: −28.0 C
Average Temperature of Bus Bars: −24.5 C
Test After Reaching Ambient Temperature for: 30 Minutes
Bus Bar Power Output:
Actual Output per bus bar in Hertz: 12,460 half cycles/second
Output Individual Wave Shape: parabolic U shape
Output Combined Effective Hertz: Direct Current (DC) Voltage (to transformer/inverter): 12.9V
Amperage (to transformer/inverter): 11,385 A
Wattage computed at bus bar: 146,877 W
Test 3
Bus Bar Power Output for Design A (This Bus Bar is powered by one power lead (2 total leads) from 62 coils and uses 31 magnets and the speed of magnetic shield rotation is 3600 RPM, operating horizontally)
Exterior Ambient Temperature: 48.0 C
Average Temperature of Coil Cores: 46.7 C
Average Temperature of Bus Bars: 49.9 C
Test After Reaching Ambient Temperature for: 30 Minutes
Bus Bar Power Output:
Actual Output per bus bar in Hertz: 10,680 half cycles/second
Output Individual Wave Shape: parabolic U shape
Output Combined Effective Hertz: Direct Current (DC)
Voltage (to transformer/inverter): 12.9V
Amperage (to transformer/inverter): 7,011 A
Wattage computed at bus bar: 90,442 W
Test 4
Bus Bar Power Output for Design A (This Bus Bar is powered by one power lead (2 total leads) from 62 coils and uses 31 magnets and the speed of magnetic shield rotation is 3600 RPM, operating horizontally)
Exterior Ambient Temperature: −27.0 C
Average Temperature of Coil Cores: −28.1 C
Average Temperature of Bus Bars: −24.4 C
Test After Reaching Ambient Temperature for: 30 Minutes
Bus Bar Power Output:
Actual Output per bus bar in Hertz: 10,680 half cycles/second
Output Individual Wave Shape: parabolic U shape
Output Combined Effective Hertz: Direct Current (DC)
Voltage (to transformer/inverter): 12.9V
Amperage (to transformer/inverter): 10,165 A
Wattage computed at bus bar: 131,140 W
Test 5
Bus Bar Power Output for Design A (This Bus Bar is powered by one power lead (2 total leads) from 62 coils and uses 31 magnets and the speed of magnetic shield rotation is 3000 RPM, operating horizontally)
Exterior Ambient Temperature: 48.0 C
Average Temperature of Coil Cores: 46.5 C
Average Temperature of Bus Bars: 49.7 C
Test After Reaching Ambient Temperature for: 30 Minutes
Bus Bar Power Output:
Actual Output per bus bar in Hertz: 8,900 half cycles/second
Output Individual Wave Shape: parabolic U shape
Output Combined Effective Hertz: Direct Current (DC)
Voltage (to transformer/inverter): 12.9V
Amperage (to transformer/inverter): 4,206 A
Wattage computed at bus bar: 54,265 W
Test 6
Bus Bar Power Output for Design A (This Bus Bar is powered by one power lead (2 total leads) from 62 coils and uses 31 magnets and the speed of magnetic shield rotation is 3000 RPM, operating horizontally)
Exterior Ambient Temperature: −27.0 C
Average Temperature of Coil Cores: −28.1 C
Average Temperature of Bus Bars: −24.4 C
Test After Reaching Ambient Temperature for: 30 Minutes
Bus Bar Power Output:
Actual Output per bus bar in Hertz: 8,900 half cycles/second
Output Individual Wave Shape: parabolic U shape
Output Combined Effective Hertz: Direct Current (DC)
Voltage (to transformer/inverter): 12.9V
Amperage (to transformer/inverter): 6,099 A
Wattage computed at bus bar: 78,684 W
Design B:
Test 1
Bus Bar Power Output for Design B (This Bus Bar is powered by one power lead (2 total leads) from 114 coils and uses 57 magnets and the speed of magnetic shield is 4200 RPM, operating horizontally)
Exterior Ambient Temperature: 48.0 C
Average Temperature of Coil Cores: 46.5 C
Average Temperature of Bus Bars: 49.7 C
Test After Reaching Ambient Temperature for: 30 Minutes
Bus Bar Power Output:
Actual Output per bus bar in Hertz: 24,220 half cycles/second
Output Individual Wave Shape: parabolic U shape
Output Combined Effective Hertz: Direct Current (DC)
Voltage (to transformer/inverter): 12.9V
Amperage (to transformer/inverter): 12,170 A
Wattage computed at bus bar: 157,000 W
Test 2
Bus Bar Power Output for Design B (This Bus Bar is powered by one power lead (2 total leads) from 114 coils and uses 57 magnets and the speed of magnetic shield is 4200 RPM, operating horizontally)
Exterior Ambient Temperature: −27.0 C
Average Temperature of Coil Cores: −28.1 C
Average Temperature of Bus Bars: −24.9 C
Test After Reaching Ambient Temperature for: 30 Minutes
Bus Bar Power Output:
Actual Output per bus bar in Hertz: 24,220 half cycles/second
Output Individual Wave Shape: parabolic U shape
Output Combined Effective Hertz: Direct Current (DC)
Voltage (to transformer/inverter): 12.9V
Amperage (to transformer/inverter): 18,785 A
Wattage computed at bus bar: 242,347 W
Design C:
Test 1
Bus Bar Power Output for Design C (This Bus Bar is powered by one power lead (2 total leads) from 236 coils and uses 118 magnets and the speed of magnetic shield is 4200 RPM, operating horizontally)
Exterior Ambient Temperature: 48.0 C
Average Temperature of Coil Cores: 46.6 C
Average Temperature of Bus Bars: 49.8 C
Test After Reaching Ambient Temperature for: 30 Minutes
Bus Bar Power Output:
Actual Output per bus bar in Hertz: 171,000 half cycles/second
Output Individual Wave Shape: parabolic U shape
Output Combined Effective Hertz: Direct Current (DC)
Voltage (to transformer/inverter): 48.8V
Amperage (to transformer/inverter): 15,230 A
Wattage computed at bus bar: 743,224 W
Test 2
Bus Bar Power Output for Design C (This Bus Bar is powered by one power lead (2 total leads) from 236 coils and uses 118 magnets and the speed of magnetic shield is 4200 RPM, operating horizontally)
Exterior Ambient Temperature: −27.0 C
Average Temperature of Coil Cores: −28.1 C
Average Temperature of Bus Bars: −24.9 C
Test After Reaching Ambient Temperature for: 30 Minutes
Bus Bar Power Output:
Actual Output per bus bar in Hertz: 171,000 half cycles/second
Output Individual Wave Shape: parabolic U shape
Output Combined Effective Hertz: Direct Current (DC)
Voltage (to transformer/inverter): 48.7V
Amperage (to transformer/inverter): 23,454 A
Wattage computed at bus bar: 1,142,220 W

Obviously, other modifications and variations of the present invention are possible in the light of the above teachings. It is therefore to be understood that changes may be made in the particular embodiments described above which are within the full intended scope of the invention as defined in the appended claims.

While the present system and method has been disclosed according to the preferred embodiment, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the system or methods disclosed herein to those particular embodiment configurations. These terms may reference the same or different embodiments, and are combinable into aggregate embodiments. The terms “a”, “an” and “the” may also mean “one or more”. Because many varying and different embodiments maybe made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

I claim:

1. An electric generator system, comprising:
an enclosure having an interior and an exterior, a top end and a bottom end, and at least one wall defining said interior of said enclosure, wherein the wall extends between said top end and said bottom end;
at least one stationary magnet mounted to a first plate, said first plate being fixedly attached to said interior of said enclosure;
at least one stationary conductor coil fixedly attached to said interior of said enclosure;
a shaft having two ends, wherein at least one end of said shaft passes through said wall;
a second plate, said second plate being rotationally mounted on said shaft and extending between and without contacting said first plate and said at least one stationary conductor coil; and
said second plate defining at least one aperture therethrough.

2. The electric generator system of claim 1, wherein said second plate is comprised of materials which substantially prevent the passing of a magnetic field therethrough.

3. The electric generator system of claim 1, wherein the system will produce electricity when said second plate rotates between the stationary conductor coil and the stationary magnet, said rotation disrupts a magnetic field generated by the stationary magnet, said rotation further allowing the passing of the magnetic field when said at least one aperture passes over the stationary magnet, and whereby electricity is created in the stationary conductor coils when the magnetic field is opened and closed upon said stationary conductor coils.

4. The electric generator system of claim 1, wherein said second plate is rotated when said shaft is rotated, and said shaft is rotated by a rotation producing device.

5. The electric generator system of claim 4, wherein said rotation producing device is a motor.

6. The electric generator system of claim 5, said motor comprises:
an enclosure having an interior and an exterior, a top end and a bottom end, and at least one wall defining said interior of said enclosure, wherein the wall extends between said top end and said bottom end;
a shaft having two ends, wherein at least one end of said shaft passes through said wall;
a plurality of magnets mounted to a plate, said plate being rotationally mounted to said shaft;
at least two stationary conductor coils fixedly attached to said interior of said enclosure;
a battery, wherein said battery at least provides rotational power to rotate said shaft; and
said plate extending between and without contacting said at least two stationary conductor coils, wherein the rotation of said plate causes a magnetic field to produce electricity in said motor, and wherein produced electricity at least charges said battery and rotates said shaft.

7. The electric generator system of claim 1, further comprising a speed control, wherein said speed control regulates the rotational speed of the second plate, whereby said electrical generator will produce electricity in a controlled quantity when the rotation of the second plate opens the magnetic field of the stationary magnet, through the aperture upon said stationary conductor coils at an appropriate rate of openings and closings in a period of time.

8. The electric generator system of claim 1, further comprising an power modification device, said device modifying the power, produced by the generator system, as desired.

9. The electric generator system of claim 8, wherein the power modification device is an inverter, wherein said inverter changes DC power to AC power.

10. The electric generator system of claim 8, wherein the power modification device is an inverter and/or a transformer.

11. The electric generator system of claim 1, further comprising:
a vacuum system, wherein said vacuum system substantially removes the air contained in the enclosure; and
a purging system, wherein said purging system injects a purging gas into said enclosure, and wherein said purging gas is different from an ambient operating atmosphere.

12. The electric generator system of claim 1, wherein said shaft rotates against at least one bearing mounted at a position where said shaft passes through said wall.

13. The electric generator system of claim 12, wherein said at least one bearing is a magnetic bearing.

14. A method for creating electricity comprising the steps of:
providing an enclosure having an interior and an exterior, a top end and a bottom end, and at least one wall defining said interior of said enclosure, wherein the wall extends between said top end and said bottom end;
positioning at least one stationary magnet mounted to a first plate in the interior of said enclosure, wherein said at least one stationary magnet generates a magnetic field;
positioning at least one stationary conductor coil in the interior of said enclosure;
mounting a second plate on a shaft having two ends, wherein at least one end of said shaft passes through said wall, and wherein the second plate extends between and without contacting said first plate and said at least one stationary conductor coil, thereby closing the magnetic field onto the stationary conducting coil, and wherein said second plate defines at least one aperture therethrough;
rotating said second plate, wherein aligning the aperture with the stationary magnet opens the magnetic field onto the stationary conductor coil; and
periodically opening and closing the magnetic field between said at least one stationary magnet and said at least one stationary conductor coil, wherein the opening and closing of the magnetic field creates electricity.

15. The method of claim 14, further comprising the step of controlling the speed of rotation of said second plate, whereby electricity will be produced in a controlled amount or quantity when the rotation of said second plate opens the magnetic field of the stationary magnet upon the stationary conductor coils at an appropriate rate of openings and closings in a desired period of time.

16. The method of claim 14, wherein the creation of electricity further comprises the steps of:
rotating said second plate between the stationary conductor coil and the stationary magnet;
disrupting the magnetic field generated by the stationary magnet, wherein the disruption comprises allowing the passing of the magnetic field when said at least one aperture passes over the stationary magnet, and whereby electricity is created in the stationary conductor coils when the magnetic field is opened and closed upon said stationary conductor coils.

17. The method of claim 14, further comprising the steps of:
positioning at least two stationary electro-magnets at a predetermined position;
positioning at least two stationary electro-magnets at a second predetermined position that is laterally spaced from the first predetermined position;
positioning at least two permanent magnet at a third predetermined position that is laterally spaced from the first and second predetermined position and said third position is in between the said first and second position;
said permanent magnets shall be an even number and the said electro-magnets shall be a number other than the number of permanent magnets;
said permanent magnets shall be positioned so that they have alternating polarity;
moving said permanent magnets by periodically energizing the electro-magnets with the same polarity as the moving permanent magnet creating motion;
utilizing said passing permanent magnet to create electricity in said stationary conductor coil which is not energized as an electro-magnet ; and
utilizing said electricity to power in part said stationary electro-magnets.

18. A motor for powering an electric DC power generator comprising:
an enclosure having an interior and an exterior, a top end and a bottom end, and at least one wall defining said interior of said enclosure, wherein the wall extends between said top end and said bottom end;
a shaft having two ends, wherein at least one end of said shaft passes through said wall;
a plurality of magnets mounted to a plate, said plate being rotationally mounted to said shaft;
at least two stationary conductor coils fixedly attached to said interior of said enclosure;
a battery, wherein said battery at least provides rotational power to rotate said shaft; and
said plate extending between said at least two stationary conductor coils, wherein the rotation of said plate causes a magnetic field to produce electricity in said motor, and wherein produced electricity at least charges said battery.

19. The motor of claim 18, wherein the stationary coil is electro magnet.

20. The motor of claim 18, further comprising a sensor, said sensor detecting the approaching magnets on the rotating plate.

21. The motor of claim 18, further comprising a controller controlling the rotational speed of the plate.
